(19) United States
(12) Patent Application Publication
(10) Pub. No.: US 2026/0067054 A1
(43) Pub. Date: Mar. 5, 2026

(54) WIRELESS COMMUNICATION SYSTEM, WIRELESS COMMUNICATION METHOD, BASE STATION, AND CONTROL PROGRAM

(71) Applicant: NTT, Inc., Tokyo (JP)

(72) Inventors: Riku OMIYA, Musashino-shi, Tokyo (JP); Junichi IWATANI, Musashino-shi, Tokyo (JP); Akira KISHIDA, Musashino-shi, Tokyo (JP); Shinya OTSUKI, Musashino-shi, Tokyo (JP); Yusuke ASAI, Musashino-shi, Tokyo (JP); Tomoaki OGAWA, Musashino-shi, Tokyo (JP); Yasushi TAKATORI, Musashino-shi, Tokyo (JP)

(73) Assignee: NTT, Inc., Tokyo (JP)

(21) Appl. No.: 18/718,206

(22) PCT Filed: Dec. 16, 2021
(86) PCT No.: PCT/JP2021/046606

§ 371 Date: Jun. 10, 2024

(51) Int. Cl. H04L 5/00; H04W 84/12

(52) U.S. Cl. CPC H04L 5/0098; H04W 84/12

(57) ABSTRACT

A wireless communication system according to an embodiment includes: a number-of-times measurement circuitry configured to measure the number of retries in which a first wireless terminal tries to perform communication in conformity with a first communication scheme; and a control circuitry configured to perform control such that the first wireless terminal performs wireless communication with a base station using a second communication scheme without using the first communication scheme until a predetermined time passes when the number of retries measured by the number-of-times measurement circuitry exceeds a preset number of retries less than a predetermined number of retries in which the second wireless terminal tries to perform communication in conformity with the first communication scheme.

### TECHNICAL FIELD

The present invention relates to a wireless communication system, a wireless communication method, a base station, and a control program.

### BACKGROUND ART

In recent wireless communication systems, it is important to increase wireless capacities to process increasing mobile traffic. For example, in IEEE 802.11be (wireless LAN), a function of installing a plurality of different wireless LAN interfaces in one device and establishing a plurality of transmission paths is adopted, and such a device is called a multi-link device (MLD) (see, for example, NPL 1). In IEEE 802.11be, it is examined to use a 6 GHz band.

### CITATION LIST

### Non Patent Literature

[NPL 1] EVGENY KHOROV et al., “Current Status and Directions of IEEE 802.11be, the Future Wi-Fi 7”, IEEE Access, VOLUME 8, 2020, Received Apr. 15, 2020, accepted May 1, 2020, date of publication May 8, 2020, date of current version May 21, 2020., pp. 88664 to 88688

### SUMMARY OF INVENTION

### Technical Problem

For example, a multi-link device is configured such that a 6 GHz band examined in a wireless LAN and frequency bands of an existing wireless LAN (for example, 2.4 GHz and 5 GHz) are used together. This multi-link device may compete with a wireless communication device which is not compatible with a multi-link device and is available only in the existing frequency bands (hereinafter referred to as an existing station). In this case, a communication speed of an existing station is reduced.

In particular, when existing frequency bands are congested, the multi-link device may hardly be able to obtain wireless resources on an existing frequency band side even if a multi-link device function is used.

The present invention has been devised in view of the above-mentioned problem, and an object of the present invention is to provide a wireless communication system, a wireless communication method, a base station, and a control program capable of preventing a multi-device-compatible wireless terminal using a low frequency band and a high frequency band from reducing a communication speed of a wireless terminal performing communication using a low frequency band without using a high frequency band.

### SOLUTION TO PROBLEM

According to an embodiment of the present invention, a wireless communication system includes a multi-device-compatible base station that accommodates one or more first wireless terminals capable of performing communication in conformity with both a first communication scheme in which a first frequency band is used and a second communication scheme in which a second frequency band higher than the first frequency band is used and one or more second wireless terminals incapable of performing communication in conformity with the second communication scheme but capable of performing communication in conformity with the first communication scheme. The wireless communication system includes: a number-of-times measurement unit configured to measure the number of retries in which the first wireless terminal tries to perform communication in conformity with the first communication scheme; and a control unit configured to perform control such that the first wireless terminal performs wireless communication with the base station using the second communication scheme without using the first communication scheme until a predetermined time passes when the number of retries measured by the number-of-times measurement unit exceeds a preset number of retries less than a predetermined number of retries in which the second wireless terminal tries to perform communication in conformity with the first communication scheme.

According to another embodiment of the present invention, a wireless communication method is a method of controlling a multi-device-compatible base station that accommodates one or more first wireless terminals capable of performing communication in conformity with both a first communication scheme in which a first frequency band is used and a second communication scheme in which a second frequency band higher than the first frequency band is used and one or more second wireless terminals incapable of performing communication in conformity with the second communication scheme but capable of performing communication in conformity with the first communication scheme. The wireless communication method includes: a number-of-times measurement step of measuring the number of retries in which the first wireless terminal tries to perform communication in conformity with the first communication scheme; and a control step of performing control such that the first wireless terminal performs wireless communication with the base station using the second communication scheme without using the first communication scheme until a predetermined time passes when the measured number of retries exceeds a preset number of retries less than a predetermined number of retries in which the second wireless terminal tries to perform communication in conformity with the first communication scheme.

According to still another embodiment of the present invention, a multi-device-compatible base station accommodates one or more first wireless terminals capable of performing communication in conformity with both a first communication scheme in which a first frequency band is used and a second communication scheme in which a second frequency band higher than the first frequency band is used and one or more second wireless terminals incapable of performing communication in conformity with the second communication scheme but capable of performing communication in conformity with the first communication scheme. The base station includes: a number-of-times measurement unit configured to measure the number of retries in which the first wireless terminal tries to perform communication in conformity with the first communication scheme; and a control unit configured to perform control such that the first wireless terminal performs wireless communication with the base station using the second communication scheme without using the first communication scheme until a predetermined time passes when the number of retries measured by the number-of-times measurement unit exceeds a preset number of retries less than a predetermined number of retries in which the second wireless terminal tries to perform communication in conformity with the first communication scheme.

### ADVANTAGEOUS EFFECTS OF INVENTION

According to the present invention, it is possible to prevent a multi-device-compatible wireless terminal using a low frequency band and a high frequency band from reducing a communication speed of a wireless terminal performing communication using a low frequency band without using a high frequency band.

### BRIEF DESCRIPTION OF DRAWINGS

FIG. 1 is a diagram illustrating a configuration example of a wireless communication system according to an embodiment.

FIG. 2 is a diagram illustrating a specific configuration example of a base station according to the embodiment.

FIG. 3 is a diagram illustrating a specific configuration example of a control device.

FIG. 4 is a flowchart illustrating an operation example of the wireless communication system.

FIG. 5 is a diagram illustrating an example of a hardware configuration of a control device.

### DESCRIPTION OF EMBODIMENTS

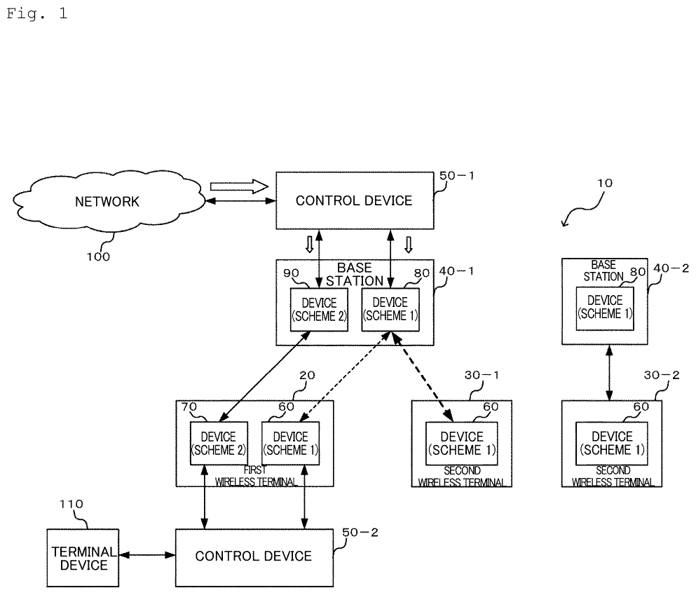

Hereinafter, a configuration example of a wireless communication system 10 according to one embodiment will be described with reference to the drawings. FIG. 1 is a diagram illustrating a configuration example of a wireless communication system 10 according to an embodiment.

As illustrated in FIG. 1, the wireless communication system 10 according to the embodiment includes, for example, a first wireless terminal 20, second wireless terminals 30-1 and 30-2, base stations 40-1 and 40-2, control devices 50-1 and 50-2, and a terminal device 110, and is connected to a network 100.

The control device 50-1 is connected to the network 100 and controls the base station 40-1 such that the base station 40-1 performs wireless communication with the first wireless terminal 20 and the second wireless terminal 30-1.

The base station 40-1 is a multi-device-compatible device, includes a device 80 serving as an access point (AP) of Scheme 1 and a device 90 serving as an AP of Scheme 2, and performs wireless communication with each of the first wireless terminal 20 and the second wireless terminal 30-1 under the control of the control device 50-1.

Scheme 1 is, for example, a wireless communication scheme of a 5 GHz band in IEEE 802.11 (wireless LAN). Scheme 1 may be a scheme in which wireless communication is performed by using a 2.4 GHz band in addition to the 5 GHz band. Scheme 2 is, for example, a wireless communication scheme of a 6 GHz band in IEEE 802.11 (wireless LAN). In the multi-device-compatible device, wireless communication can be performed by using Schemes 1 and 2 at the same time.

The base station 40-1 may be integrated with the control device 50-1. That is, the base station 40-1 may have each function of the control device 50-1.

The base station 40-2 includes a device 80 serving as an AP of Scheme 1 and performs wireless communication with, for example, the second wireless terminal 30-2.

The first wireless terminal 20 is a multi-device-compatible wireless terminal (STA) that includes devices 60 and 70 respectively supporting communication schemes (Schemes 1 and 2) of devices 80 and 90 included in the multi-device-compatible base station 40-1 supporting both 5 GHz and 6 GHz bands.

The device 60 supports a communication scheme of the device 80 (Scheme 1: first communication scheme) included in the base station 40-1 and performs wireless communication with the device 80. The device 70 supports a communication scheme of the device 90 (Scheme 2: second communication scheme) included in the base station 40-1 and performs wireless communication with the device 90.

Each of the second wireless terminals 30-1 and 30-2 is a wireless terminal that includes the device 60 supporting only a communication scheme (Scheme 1) of the device 80 included in the base station 40-1 or 40-2. For example, in the second wireless terminal 30-1, the device 60 supporting only a 5 GHz band performs wireless communication with the device 80 of the base station 40-1. In the second wireless terminal 30-2, the device 60 supporting only the 5 GHz band performs wireless communication with the device 80 of the base station 40-2.

The control device 50-2 is connected to the terminal device 110 and controls the first wireless terminal 20 such that, for example, the first wireless terminal 20 and the base station 40-1 perform wireless communication. The control device 50-2 may have substantially the same configuration as the control device 50-1. The terminal device 110 is a computer that controls the control device 50-2.

That is, the wireless communication system 10 includes a first wireless terminal 20 that is capable of performing communication in conformity with both the first communication scheme using a first frequency band (5 GHz) and the second communication scheme using a second frequency band (6 GHz) higher than the first frequency band, and a multi-device-compatible base station 40-1 that accommodates the second wireless terminals 30-1 and 30-2 incapable of performing communication in conformity with the second communication scheme but capable of performing communication in conformity with the first communication scheme.

However, in the wireless communication system 10, it can be assumed that each of the second wireless terminals 30-1 and 30-2 competes with the first wireless terminal 20 capable of performing communication in conformity with the same communication scheme (Scheme 1).

Accordingly, for example, the control device 50-1 performs control such that the first wireless terminal 20 is prevented from reducing a communication speed of the second wireless terminal 30-1 or the like.

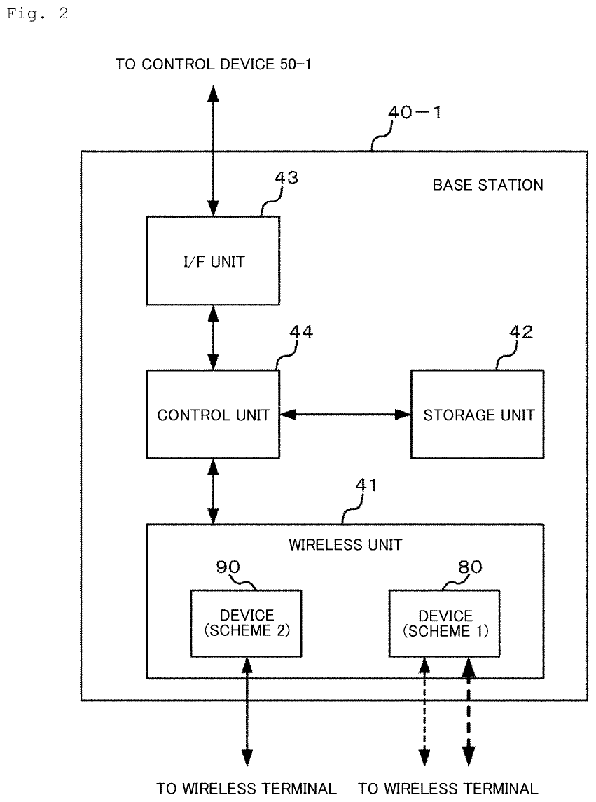

Next, a specific configuration example of the base station 40-1 will be described. FIG. 2 is a diagram illustrating a specific configuration example of the base station 40-1 according to the embodiment. As illustrated in FIG. 2, the base station 40-1 includes, for example, a wireless unit 41, a storage unit 42, an interface (I/F) unit 43, and a control unit 44.

The wireless unit 41 includes the above-described devices 80 and 90, and performs wireless communication with, for example, the first wireless terminal 20 and the second wireless terminal 30-1.

The storage unit 42 stores information or the like received by the base station 40-1 through the wireless unit 41 or the I/F unit 43.

The I/F unit 43 is a communication interface for communication with the control device 50-1.

The control unit 44 controls each unit included in the base station 40-1.

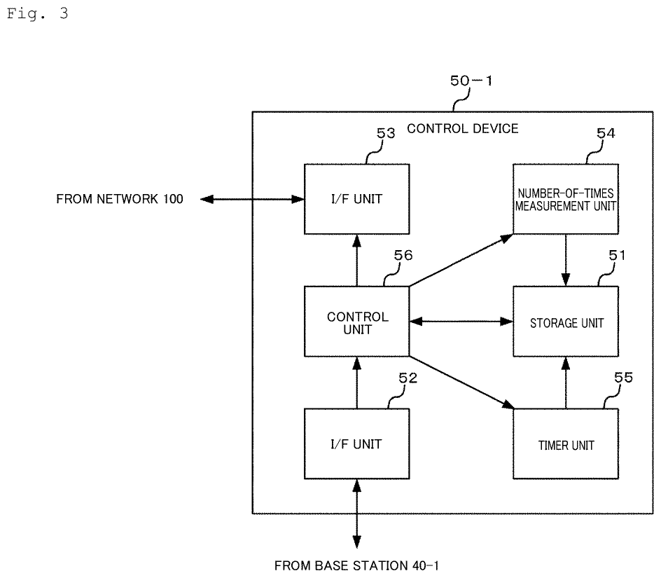

Next, a specific configuration example of the control device 50-1 will be described. FIG. 3 is a diagram illustrating a specific configuration example of the control device 50-1. As illustrated in FIG. 3, the control device 50-1 includes, for example, a storage unit 51, an interface (I/F) unit 52, an interface (I/F) unit 53, a number-of-times measurement unit 54, a timer unit 55, and a control unit 56.

The storage unit 51 is a storage device which stores data in the control device 50-1.

The I/F unit 52 is a communication interface for communication with the base station 40-1. The I/F unit 53 is a communication interface for communication with the network 100.

The number-of-times measurement unit 54 measures the number of retries in which the first wireless terminal 20 tries communication via the I/F unit 52 in conformity with the first communication scheme using the first frequency band (5 GHz) and outputs a measurement result to the storage unit 51.

The timer unit 55 measures a time or the like required for each processing or the like in the control device 50-1, and outputs the time or the like to the storage unit 51.

The control unit 56 controls each unit included in the control device 50-1. For example, when the number of retries measured by the number-of-times measurement unit 54 exceeds a preset number of retries that is less than a predetermined number of retries in which second wireless terminals 30-1 and 30-2 try communication in conformity with the first communication scheme via the I/F unit 52, the control unit 56 performs control such that the first wireless terminal 20 performs wireless communication with the base station 40-1 using the second communication scheme without using the first communication scheme until a predetermined time passes.

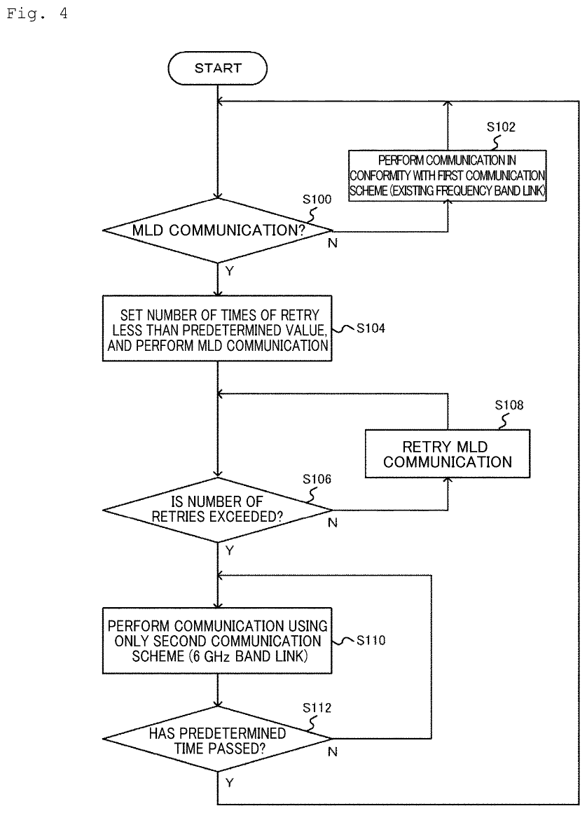

Next, an operation example of the wireless communication system 10 will be described. FIG. 4 is a flowchart illustrating an operation example of the wireless communication system 10.

In the wireless communication system 10, for example, the control device 50-1 determines whether the base station 40-1 and the first wireless terminal 20 perform MLD communication (S100), and moves to processing of S102 when the MLD communication is not performed (No in S100). The processing moves S104 when the MLD communication is performed (Yes in S102).

In the processing of S102, the base station 40-1 and the first wireless terminal 20 perform communication in conformity with the first communication system (existing frequency band link). At this time, the base station 40-1 sets the number of retries of the first frequency band to a predetermined value and performs wireless communication with the first wireless terminal 20 using the first frequency band.

In the processing of S104, the base station 40-1 sets the number of retries of the first frequency band less than the predetermined value under the control of the control device 50-1 and performs the MLD communication with the first wireless terminal 20. At this time, the base station 40-1 sets the number of retries of the first frequency band to the above-described set number of retries.

Next, the control device 50-1 determines whether the number of retries in which the base station 40-1 and the first wireless terminal 20 tries communication in conformity with the first communication scheme in the MLD communication exceeds the set number of retries (S106). When the number of retries does not exceed the set number of retries (No in S106), the control device 50-1 moves to the processing of S108. When the number of retries exceeds the set number of retries (Yes in S106), the control device 50-1 moves to the processing of S110.

In the processing in S108, the base station 40-1 and the first wireless terminal 20 retry the MLD communication.

In the processing of S110, the base station 40-1 and the first wireless terminal 20 perform communication using only the second communication scheme (6 GHz band link).

In the processing of S112, the control device 50-1 determines whether the predetermined time has passed after the base station 40-1 and the first wireless terminal 20 start the communication using only the second communication scheme. The processing returns to S110 when it is determined that the predetermined time has not passed (No in S112). When it is determined that the predetermined time has passed (Yes in S112), the processing returns to S100.

In this way, when the measured number of retries exceeds the set number of retries, the wireless communication system 10 according to the embodiment performs control such that the first wireless terminal 20 performs wireless communication with the base station 40-1 using the second communication scheme without using the first communication scheme until the predetermined time passes. Accordingly, the wireless communication system 10 can prevent the multi-device-compatible first wireless terminal 20 from reducing the communication speed of the second wireless terminal 30-1 or the like.

When the 5 GHz band and 2.4 GHz band are used as the first communication scheme, the wireless communication system 10 may perform control such that the first wireless terminal 20 performs wireless communication with the base station 40-1 using the second communication scheme without using only the 5 GHz and or the 2.4 GHz band as the first communication scheme until the predetermined time passes.

Some or all of the functions of the control device 50-1 may be configured by hardware such as a programmable logic device (PLD) or field programmable gate array (FPGA), or may be configured as a program executed by a processor such as a CPU.

For example, the control device 50-1 can be implemented using a computer and a program, and the program can be recorded on a recording medium or provided via a network.

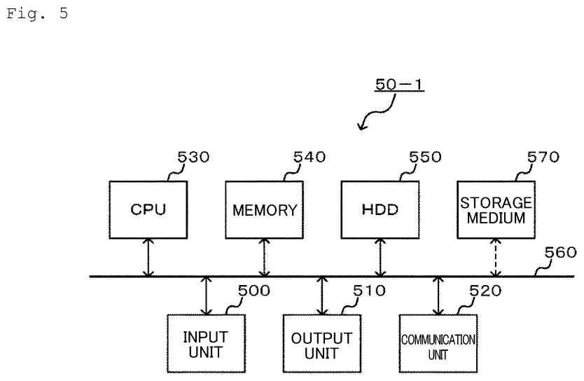

FIG. 5 is a diagram illustrating a hardware configuration example of the control device 50-1. As illustrated in FIG. 5, the control device 50-1 has functions of a computer in which an input unit 500, an output unit 510, a communication unit 520, a CPU 530, a memory 540, and an HDD 550 are connected with each other via a bus 560. The control device 50-1 is configured to be able to input and output data to and from a computer-readable storage medium 570.

The input unit 500 is, for example, a keyboard, a mouse, or the like. The output unit 510 is, for example, a display device such as a display. The communication unit 520 is, for example, a network interface.

The CPU 530 controls the units included in the control device 50-1 and performs predetermined processing or the like. The memory 540 and the HDD 550 are storage units that store data or the like.

The storage medium 570 is capable of storing a program for executing the functions of the control device 50-1. An architecture of the control device 50-1 is not limited to the example illustrated in FIG. 5.

### REFERENCE SIGNS LIST

10 Wireless communication system
20 First wireless terminal
30-1, 30-2 Second wireless terminal
40-1, 40-2 Base station
41 Wireless unit
42 Storage unit
43 I/F unit
44 Control unit
50-1, 50-2 Control device
51 Storage unit
52, 53 I/F unit
54 Number-of-times measurement unit
55 Timer unit
56 Control unit
60, 70, 80, 90 Device
100 Network
500 Input unit
510 Output unit
520 Communication unit
530 CPU
540 Memory
550 HDD
560 Bus
570 Storage medium

1. A wireless communication system that includes a multi-device-compatible base station that accommodates one or more first wireless terminals capable of performing communication in conformity with both a first communication scheme in which a first frequency band is used and a second communication scheme in which a second frequency band higher than the first frequency band is used and one or more second wireless terminals incapable of performing communication in conformity with the second communication scheme but capable of performing communication in conformity with the first communication scheme, the wireless communication system comprising:
number-of-times measurement circuitry configured to measure the number of retries in which the first wireless terminal tries to perform communication in conformity with the first communication scheme; and
control circuitry configured to perform control such that the first wireless terminal performs wireless communication with the base station using the second communication scheme without using the first communication scheme until a predetermined time passes when the number of retries measured by the number-of-times measurement circuitry exceeds a preset number of retries less than a predetermined number of retries in which the second wireless terminal tries to perform communication in conformity with the first communication scheme.

2. The wireless communication system according to claim 1, where the first and second communication schemes are wireless communication schemes conforming to a wireless LAN standard.

3. A wireless communication method of controlling a multi-device-compatible base station that accommodates one or more first wireless terminals capable of performing communication in conformity with both a first communication scheme in which a first frequency band is used and a second communication scheme in which a second frequency band higher than the first frequency band is used and one or more second wireless terminals incapable of performing communication in conformity with the second communication scheme but capable of performing communication in conformity with the first communication scheme, the wireless communication method comprising:
measuring the number of retries in which the first wireless terminal tries to perform communication in conformity with the first communication scheme; and
performing control such that the first wireless terminal performs wireless communication with the base station using the second communication scheme without using the first communication scheme until a predetermined time passes when the measured number of retries exceeds a preset number of retries less than a predetermined number of retries in which the second wireless terminal tries to perform communication in conformity with the first communication scheme.

4. The wireless communication method according to claim 3, wherein the first and second communication schemes are wireless communication schemes conforming to a wireless LAN standard.

5. A multi-device-compatible base station that accommodates one or more first wireless terminals capable of performing communication in conformity with both a first communication scheme in which a first frequency band is used and a second communication scheme in which a second frequency band higher than the first frequency band is used and one or more second wireless terminals incapable of performing communication in conformity with the second communication scheme but capable of performing communication in conformity with the first communication scheme, the base station comprising:
a number-of-times measurement circuitry configured to measure the number of retries in which the first wireless terminal tries to perform communication in conformity with the first communication scheme; and
control circuitry configured to perform control such that the first wireless terminal performs wireless communication with the base station using the second communication scheme without using the first communication scheme until a predetermined time passes when the number of retries measured by the number-of-times measurement circuitry exceeds a preset number of retries less than a predetermined number of retries in which the second wireless terminal tries to perform communication in conformity with the first communication scheme.

6. The base station according to claim 5, where the first and second communication schemes are wireless communication schemes conforming to a wireless LAN standard.

7. A non-transitory computer-readable storage medium storing a program causing a computer to function as each circuitry of the base station according to claim 5.
